(19) United States
(12) Patent Application Publication
(10) Pub. No.: US 2022/0119161 A1
(43) Pub. Date: Apr. 21, 2022

(54) HERMETIC STOPPER FOR A NOZZLE

(71) Applicant: SARTORIUS STEDIM FMT SAS, Aubagne (FR)

(72) Inventor: Frédéric BAZIN, Cassis (FR)

(73) Assignee: SARTORIUS STEDIM FMT SAS, Aubagne (FR)

(21) Appl. No.: 17/424,583

(22) PCT Filed: Feb. 7, 2020
(86) PCT No.: PCT/FR2020/000025

§ 371 Date: Jul. 21, 2021

(30) Foreign Application Priority Data
Feb. 8, 2019 (FR) 1901276

(51) Int. Cl. B65D 39/00; B65D 39/16; A61J 1/14; B65D 47/12

(52) U.S. Cl. CPC B65D 39/0017; B65D 47/121; A61J 1/1412; B65D 39/16

(57) ABSTRACT

A stopper configured to hermetically close a nozzle intended to contain a biopharmaceutical fluid with a cylindrical bore of diameter (D1) and a flange having a groove. The stopper has a body with a front part with a cylindrical outer wall about an axis A, with a diameter at rest greater than (D1), intended to be received under stress in the cylindrical bore of the nozzle, a stop disc extending a rear part of the body radially towards the outside and extending in a plane transverse to the axis. The body and the stop disc are rotationally symmetric about the axis A. The stop disc includes an annular bulge, interposed radially between a first annular shoulder and a second annular shoulder, the bulge extending forward from the stop disc and being intended to be received in the groove in the flange of the nozzle.

### TECHNICAL FIELD

The present invention relates to hermetic stoppers for a nozzle, in particular in the field of containers for biopharmaceutical fluids

### BACKGROUND

In the field of biopharmaceutical fluids, as in the field of foodstuffs, the use of “triclamp” type connectors is very common. In this type of connection, two similar nozzles are placed face to face with an interposed gasket, followed by the use of a screw-on cuff (circumferentially tightened hinged collar) with tapered parts to squeeze the nozzles against each other by compressing the interposed gasket, which creates a hermetic connection.

In certain logistics operations relating to biopharmaceutical fluids, a sub-assembly is provided with a hermetically sealed nozzle pending a subsequent connection. This sealed nozzle is formed by a stopper taking the place of the missing nozzle on which the screw-on cuff is installed, as shown in section in FIG. 8. The screw-on cuff may pose a risk of damage by face-to-face contact with plastic bags of biopharmaceutical fluid, by the same sub-assembly or adjacent sub-assemblies.

Therefore, it has become necessary to provide a simpler solution, which reduces the risk of damage by contact with plastic bags.

Therefore, to this end, a stopper configured to hermetically close a nozzle intended to contain a biopharmaceutical fluid is proposed; said nozzle having a cylindrical bore of diameter D1 and a flange with a groove, the stopper comprising:
a body comprising a front part with a cylindrical outer wall about an axis A, with a diameter at rest substantially greater than, intended to be received under stress in the cylindrical bore of diameter D1 of the nozzle,
a stop disc, extending a rear part of the body at least radially towards the outside and generally extending in a plane transverse to the axis,

the body and the stop disc being rotationally symmetric about the axis A,

the stop disc comprising an annular bulge, interposed radially between a first annular shoulder and a second annular shoulder, the bulge extending forward from the stop disc and being intended to be received in the groove in the flange of the nozzle,

such that when the stopper is inserted into the nozzle, two hermetic barriers are formed between an internal space of the nozzle and the external environment, namely a first barrier at the wall of the body of the stopper received in the internal bore and a second barrier at the mating point of the bulge in the groove.

Advantageously, the use of a triclamp connector type cuff is avoided. The use of a gasket is also avoided, as the bulge acts, at least in part, as a gasket.

Such a stopper has a modest, or even very attractive cost price and, as a result, may be a single-use part.

In various embodiments of the invention, use may also possibly be made of one and/or the other of the following arrangements, alone or in combination.

According to one aspect, the body and the stop disc may be formed integrally in a single part in an elastomeric material. It is preferably possible to use a silicone or a TPE (thermoplastic elastomer), for example, for this single material part. However, other bases are not excluded, such as polyurethane, polyester, polyethylene, polypropylene, polyurethane or polyamide type copolymers.

According to one aspect, a sufficiently elastic material, which provides flexibility such that the hardness of the body of the stopper is less than Shore 70A, is chosen.

According to one aspect, a sufficiently elastic material, which provides flexibility such that the hardness of the body of the stopper is between 50A and 80A Shore, is chosen.

According to one aspect, the stopper may be formed as a bi-material part in silicone or TPE, with a first portion made from a first material and a second portion made from a second material, the first material being more flexible than the second material. The first material may be a silicone or a TPE (thermoplastic elastomer) the second material may be a polypropylene, a polyamide or a polybutylene terephthalate.

According to one aspect, the cylindrical outer wall of the front part, as well as the annular bulge, may be formed in the first portion. A good contact is thus obtained, which forms a hermetic barrier. The body is flexible and peripheral retaining means more rigid.

According to one aspect, provision may also be made for peripheral retaining means extending the stop disc at least forward with a return towards the axis in order to rest on the rear of the flange.

This increases the effectiveness of the second barrier. Furthermore, this prevents accidental removal, strengthens the hold obtained by insertion under stress of the body.

According to one aspect, the peripheral retaining means are formed by a continuous circumferential annular rim. This forms a completely rotationally symmetric configuration about the axis A.

According to one aspect, the peripheral retaining means are formed by retaining claws arranged circumferentially discontinuously. Advantageously, such claws may be deformed more easily, the claws may return much further towards the axis than the annular rim.

According to one aspect, the retaining claws may be formed integrally or in another material, with a predefined number of claws, for example, two, three or four. Depending on the configuration and the client's requirements, it is thus possible to adjust the retaining force imparted by the retaining device.

According to one aspect, the bulge extends annularly at a diameter D3 of between 18 mm and 40 mm. This covers the standard dimensions, which are ¾ inch and 1.5 inches.

According to one aspect, the bearing interface between the body of the stopper and the bore extends over an axial length L1 of at least 3 mm, and preferably at least 6 mm, and preferably at most 10 mm. A large bearing surface is thus formed for sealing and mechanical retention.

According to one aspect, provision is made for the width and depth of the groove 23 to substantially correspond to the width and projection of the bulge, in order to thus obtain a correspondence in shape between the bulge and groove. This ensures that the second barrier is properly effective.

According to one aspect, as regards dimensional conditions, provision may be made for D1′ to be between 1.05 D1 and 1.25 D1 or for D1′ to be between D1+1 mm and D1+5 mm. Depending on the type of silicone material, the compression ratio may be more or less significant. It is possible to choose a ratio D1′=1.20 D1. This represents a good compromise between the moderate insertion force and a good hold and a good seal.

According to one aspect, provision is made for a non-use control flange, with a front ring and a rear ring and one or more fusible zones joining the front ring to the rear ring. Thus, following installation of the stopper, the use control flange is added and this ensures that the fluid contained in the nozzle and/or the associated container has not been opened and in contact with fresh air.

According to one aspect, a gripping device, in the form of a tongue or handle, is provided. This facilitates removal of the stopper for subsequent permitted use of the biopharmaceutical fluid. Provision may be made for the gripping device to be squeezed between two fingers in order for it to then be pulled axially towards the rear of the stopper.

According to one aspect, the gripping device protrudes backward from the stop disc of the stopper. In particular, the gripping device may be formed integrally with the body of the stopper, it may be in a central axial position.

Finally, the present invention also relates to an assembly comprising, on the one hand, a nozzle (2) intended to contain a biopharmaceutical fluid, said nozzle having a cylindrical bore (21) of diameter D1 and a flange with a groove (23) and, on the other hand, a stopper as described above. In particular, the assembly in question may contain a bag of high added value biopharmaceutical products, a filter, other tubes and nozzles, etc.

### BRIEF DESCRIPTION OF THE DRAWINGS

Other aspects, aims and advantages of the invention will become apparent on reading the following description of an embodiment of the invention, provided by way of a non-limiting example. The invention will also be better understood in relation to the appended drawings, in which:

FIG. 1A is a general sectional view of a stopper according to a first embodiment of the invention,

FIG. 1B is a general front view of the stopper in FIG. 1,

FIG. 2 is a sectional view of another embodiment,

FIG. 3 is a sectional view of yet another embodiment,

FIG. 4 is a sectional view of yet another embodiment,

FIG. 5 is a sectional view of yet another embodiment,

FIG. 6 is a sectional view of yet another embodiment,

FIG. 7 is a sectional view of yet another embodiment,

FIG. 8 shows the prior art.

### DESCRIPTION OF EMBODIMENTS

In the different figures, the same references relate to identical or similar components. For reasons of clarity, certain components cannot be represented to scale.

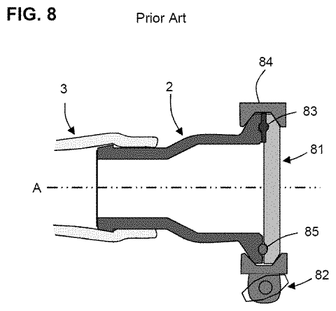

FIG. 8 shows a conventional solution for which it is necessary to hermetically seal a nozzle 2. In the example illustrated, a flexible tube 3 is connected to said nozzle 2. The nozzle, stopper and tube form part of assembly intended to contain a biopharmaceutical fluid. Such an assembly may comprise one or more bags, one or more filters, one or more tubes, one or more stop valves, etc.

An O-ring 85 or, alternatively, a flat gasket with a bulge 83 is placed on the face of the nozzle, then a stopper identified as 81 is placed over the top. A closure with cuffs 84 is then installed and the screw 82 is tightened to squeeze the cuff and, thanks to the bevelled shapes, to apply an axial pressure on the gasket to ensure a good level of sealing.

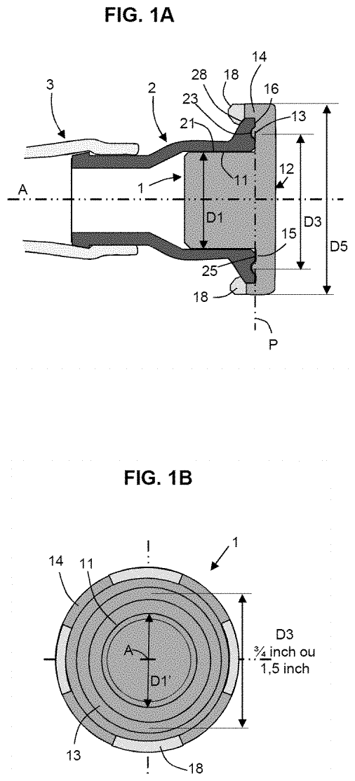

FIGS. 1A and 1B show a first embodiment of the invention. There is a nozzle 2 with conventional dimensions in the field of biopharmaceutical fluids. For example, the internal diameter of the nozzle may range from 10 mm to 30 mm and the length of the nozzle may range from 10 mm to 50 mm.

In the example illustrated, a flexible tube 3 is inserted into the rear part of the nozzle as recognised in itself. The front part of the nozzle comprises a tubular body with a cylindrical bore 21 of diameter D1 and a flange 28 generally extending in a plane transverse to the axis A radially towards the outside. The flange 28 comprises a groove 23, intended to receive a component forming a gasket.

The groove 23 extends annularly at a diameter D3 of between 18 mm and 40 mm. In particular, two specific values are considered for the diameter D3 namely three quarters of an inch and one and a half inches (¾ inch and 1.5 inches).

The present invention provides a stopper 1, which will form a single part for hermetically sealing the nozzle 2 and thus replacing the solution illustrated in FIG. 8. The stopper 1 may be envisaged as a single-use part, namely that is not recycled following shipment of the biopharmaceutical assembly for a client.

In another configuration, the stopper may effectively be recycled, sterilised and used several times.

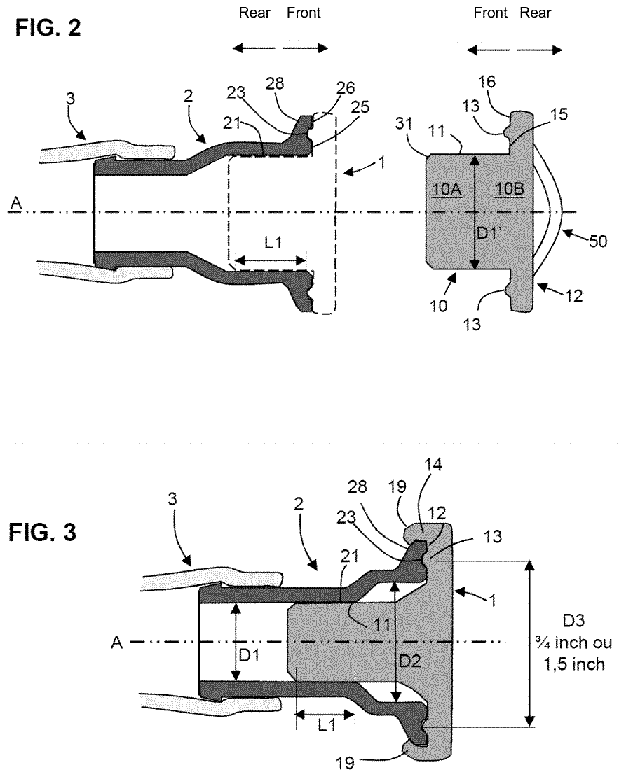

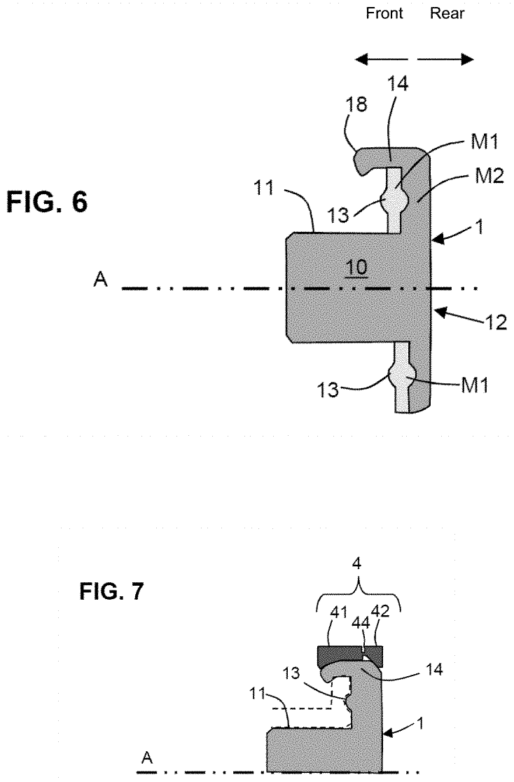

In the terminology used throughout the present document, it should be noted that the terms front and rear are used relative to an insertion direction of a component, in this case insertion of the stopper 1 into the nozzle 2. The directions front and rear appear in FIGS. 2, 5 and 6 and apply similarly to other embodiments.

The stopper comprises a body 10 comprising a front part 10A and a rear part 10B.

The front part 10A comprises an outer wall 11, which is cylindrical about an axis A.

The front part 10A has a diameter at rest Dr substantially greater than D1. According to one example, Dr may be between 1.05 D1 and 1.25 D1; according to another example, D1′ may be between D1+1 mm and D1+5 mm. D1′ may be close to 1.2 D1.

The front part 10A is intended to be received under stress in the cylindrical bore 21 of the nozzle 2.

The stopper 1 comprises a stop disc 12, extending a rear part 10B of the body at least radially towards the outside and generally extending in a plane P transverse to the axis A.

The external diameter of the stopper identified as D5 may be between 1.6×D1 and 2×D1.

The stop disc 12 comprises a first annular shoulder 15, which extends in a plane P transverse to the axis A and a second annular shoulder 16 situated radially further outside, in the same transverse plane P.

The stop disc 12 comprises an annular bulge 13, interposed radially between the first annular shoulder 15 and the second annular shoulder 16.

The annular bulge 13 is intended to be received in the groove 23 of the flange 28 of the nozzle 2. The annular bulge 13 generically forms a component forming a gasket.

On the flange of the nozzle, provision is made for a first bearing surface 25 facing the first annular shoulder 15 of the stopper and a second bearing surface 26 facing the second annular shoulder 16 of the stopper.

Moving towards the outside, the stop disc is extended by a return rim identified as 14, which extends forward.

In certain embodiments, provision is made for peripheral retaining means, to secure the position of the stopper once installed on the nozzle 2.

In the example illustrated in FIG. 1, the peripheral retaining means are formed as retaining claws 18.

In the example illustrated, four retaining claws are shown regularly spaced around the circumference of the return rim 14 of the stopper.

Naturally, the number of retaining claws may differ, there may be 2, 3 or any number equal to or greater than 5.

In FIG. 2, the stopper does not have a retaining flange, which may be envisaged where the stopper's retention in the nozzle is sufficiently ensured by friction and the residual stress between the two parts once assembly has been completed.

The engagement length L1 of the body inside the bore 21, as well as the residual radial stress following insertion, may be such that retention is sufficient for certain applications.

According to one example, the engagement length L1 of the body inside the bore 21 may be equal to at least 3 mm, according to another example, the engagement length L1 may be equal to at least 5 mm, up to 10 mm.

The traction force for removing the stopper may be calibrated to be greater than 30 Newtons. This value may be considered for all health embodiments.

It should be noted that the front part 10A of the body of the stopper may comprise an inlet chamfer 31, which facilitates the start of insertion of the stopper 1 into the nozzle 2.

FIG. 2 shows that a gripping device 50 may also be provided. This gripping device 50 may take the form of a handle or tongue. A user may squeeze the gripping device between two fingers to then pull it axially towards the rear of the stopper; which makes it easier to remove the stopper for subsequent permitted use of the biopharmaceutical fluid.

The gripping device 50 protrudes backward from the stop disc 12 of the stopper. The gripping device 50 may protrude backward, for example, by a dimension of at least 10 mm.

The gripping device 50 may be formed integrally with the body of the stopper, it may be in a central axial position.

FIG. 3 shows a variant of the nozzle, which comprises a bore of a small diameter D1 with a longer length and an enlargement of diameter D2 just before the flange 28. In this case, the hermetic contact between the stopper and the nozzle is made at the small diameter D1.

In this example, peripheral retaining means are shown formed by an external continuous circumferential annular rim 19. This external annular rim has an external chamfer, which aids its insertion into the nozzle, sufficient radial deformation is provided to enable the annular rim to pass the maximum external diameter of the nozzle.

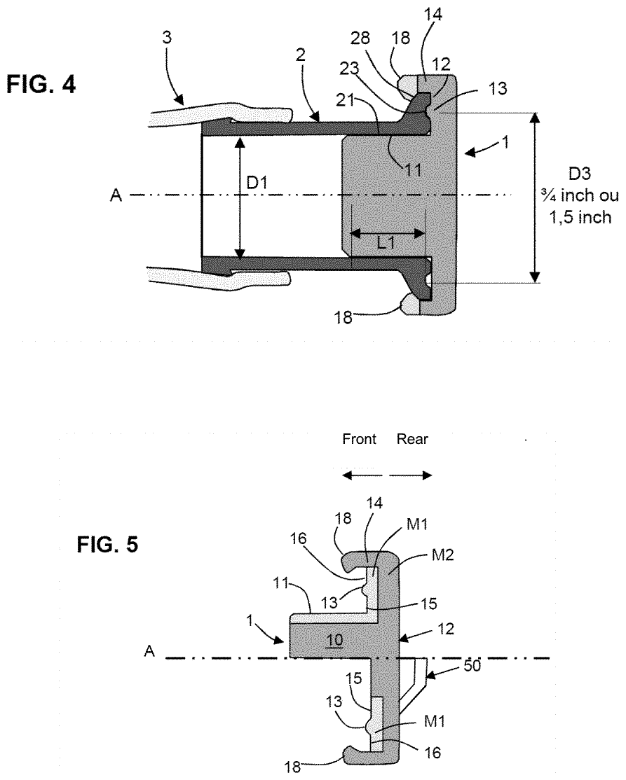

FIG. 4 shows another variant of the nozzle, which has a bore of internal diameter D1 over its entire axial length. D1 has a value greater than that in FIG. 3.

FIG. 5 shows another variant of the stopper made from two materials. The part above the axis line shows an example of material forming, while the part below the axis line shows another example.

The stopper 1 is formed as a bi-material part with a first portion M1 made from a first material, for example from silicone or a thermoplastic elastomer, and a second portion M2 made from a second material, the first material being more flexible than the second material.

For the second material M2, it is possible to choose polyurethane, polyester, polyethylene, polypropylene, polyurethane or polyamide copolymer type bases.

In the upper section of FIG. 5, the flexible material M1 forms the cylindrical outer wall 11 of the body of the stopper, as well as the bulge 13 and the bearing surfaces 15, 16 that surround it. It is noted that once the stopper is installed in the nozzle, the first material M1 is not accessible from the outside, only the components formed by the second material are.

In the lower section of FIG. 5, the flexible material M1 forms the bulge 13 and the bearing surfaces 15, 16 that surround it, but the body 11 of the stopper 1 is formed from the second material M2.

In the exemplary embodiment in FIG. 7, provision is made for a non-use control flange 4, with a front ring 41 and a rear ring 42 and one or more fusible zones 44 joining the front ring to the rear ring.

In order to insert the flange in question, for example, a thermal process is provided, with heating of the flange, which has a more elastic shape in this case, while after cooling its elasticity will have decreased and the only solution for removing it from the peripheral rim 14 will be to break the fusible areas 44.

1. A stopper configured to hermetically close a nozzle intended to contain a biopharmaceutical fluid, said nozzle having a cylindrical bore of diameter (D1) and a flange with a groove, the stopper comprising:
a body comprising a front part with a cylindrical outer wall about an axis A, with a diameter at rest (D1′) substantially greater than (D1), intended to be received under stress in the cylindrical bore of the nozzle,
a stop disc, extending a rear part of the body at least radially towards the outside and generally extending in a plane transverse to the axis,
the body and the stop disc being rotationally symmetric about the axis A,
the stop disc comprising an annular bulge, interposed radially between a first annular shoulder and a second annular shoulder, the bulge extending forward from the stop disc and being intended to be received in the groove of the flange of the nozzle,
such that at least two hermetic barriers are formed between an internal space of the nozzle and the external environment, namely a first barrier at the wall of the body received in the internal bore and a second barrier at the mating point of the bulge in the groove.

2. The stopper according to claim 1, wherein the body and the stop disc are formed integrally in a single part in an elastomeric material.

3. The stopper according to claim 1, formed as a bi-material part in silicone or thermoplastic elastomer, with a first portion (M1) made from a first material and a second portion (M2) made from a second material, the first material being more flexible than the second material.

4. The stopper according to claim 3, wherein the cylindrical outer wall of the front part, as well as the annular bulge, are formed in the first portion (M1).

5. The stopper according to claim 1, wherein provision is also made for peripheral retaining means extending the stop disc at least forward with a return towards the axis in order to rest on the rear of the flange.

6. The stopper according to claim 5, wherein the peripheral retaining means are formed by an external continuous circumferential annular rim.

7. The stopper according to claim 5, wherein the peripheral retaining means are formed by retaining claws arranged circumferentially discontinuously.

8. The stopper according to claim 1, wherein the bearing interface between the body of the stopper and the bore extends over an axial length L1 of at least 3 mm.

9. The stopper according to claim 1, wherein provision is made for a non-use control flange, with front ring and a rear ring and one or more fusible zones joining the front ring to the rear ring.

10. The stopper according to claim 1, wherein provision is made for a gripping device, in the form of a tongue or handle.

11. The stopper according to claim 10, wherein the gripping device protrudes backward from the stop disc of the stopper.

12. An assembly comprising, on the one hand, a nozzle intended to contain a biopharmaceutical fluid, said nozzle having a cylindrical bore of diameter D1 and a flange with a groove and, on the other hand, a stopper according to claim 1.

13. The stopper according to claim 4, wherein provision is also made for peripheral retaining means extending the stop disc at least forward with a return towards the axis in order to rest on the rear of the flange.

14. The stopper according to claim 8, wherein provision is made for a non-use control flange, with front ring and a rear ring and one or more fusible zones joining the front ring to the rear ring.

15. The stopper according to claim 9, wherein provision is made for a gripping device, in the form of a tongue or handle.
